(19) United States
(12) Patent Application Publication
(10) Pub. No.: US 2012/0316680 A1
(43) Pub. Date: Dec. 13, 2012

(54) TRACKING AND FOLLOWING OF MOVING OBJECTS BY A MOBILE ROBOT

(75) Inventors: Charles F. Olivier, III, Bothell, WA (US); Jean Sebastien Fouillade, Redmond, WA (US); Adrien Felon, Seattle, WA (US); Jeffrey Cole, Seattle, WA (US); Nathaniel T. Clinton, Sammamish, WA (US); Russell Sanchez, Redmond, WA (US); Francois Burianek, Kirkland, WA (US); Malek M. Chalabi, Redmond, WA (US); Harshavardhana Narayana Kikkeri, Bellevue, WA (US)

(73) Assignee: Microsoft Corporation, Redmond, WA (US)

(21) Appl. No.: 13/158,465

(22) Filed: Jun. 13, 2011

(51) Int. Cl. B25J 13/08

(52) U.S. Cl. 700/258; 901/1; 901/46

(57) ABSTRACT

A robot tracks objects using sensory data, and follows an object selected by a user. The object can be designated by a user from a set of objects recognized by the robot. The relative positions and orientations of the robot and object are determined. The position and orientation of the robot can be used so as to maintain a desired relationship between the object and the robot. Using the navigation system of the robot, during its movement, obstacles can be avoided. If the robot loses contact with the object being tracked, the robot can continue to navigate and search the environment until the object is reacquired.

### BACKGROUND

The motion of a mobile robot is commonly controlled by directing the robot to move in a particular direction, or along a designated path, or to a specific location. A robot can include sensors to allow it to avoid obstacles while moving in the designated direction, or to the designated location, or along a designated path.

For example, robots are commonly controlled remotely by an operator who is watching a live video feed, often provided by a camera on the robot. While viewing the video, an operator can direct the robot to move in various directions and to perform various operations. One challenge with this kind of control is a frequent need to adjust camera and microphone positions on the robot.

As another example, robots commonly are directed to move about a room or rooms to perform various tasks. Such tasks may include cleaning or taking pictures or gathering other sensory inputs. During such tasks, the robot may move autonomously, and avoid obstacles, and thus involving little or no control by an operator.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

By combining the ability of a robot to identify and track objects, such as a person, using sensory data, such as audio and video information, with the ability to measure position and orientation of an object, a robot can be instructed to track and follow an object. The object to be tracked and followed can be designated by a user from a set of objects recognized by the robot. The tracked object can be a person. In many instances, an object can be recognized and tracked by recognizing or tracking just a portion of the object, such as a face or head.

Objects can be recognized, for example, using any of a variety of pattern recognition techniques applied to sensory inputs of the robot. For example, facial recognition or shape recognition can be applied to image data. Speech recognition or sound source localization can be applied to audio data gathered by a set of microphones.

The user may be local or remote. A local user can provide an instruction to the robot to follow an object, including himself or herself, based on his or her voice or other user input. A remote user could be enabled, through a user interface, to input a selection of an object from one or more objects recognized by the robot.

Given a selected object, the relative positions and orientations of the object and the robot can be determined, such as an x, y position and orientation. The motion control system can then control the motion of the robot to maintain a specified relative position and orientation with respect to the tracked object. During this motion, obstacles can be avoided using conventional obstacle avoidance techniques. In some cases, an obstacle will obscure the sensory information from which the tracked object is recognized. In this case, the robot can continue to navigate and search the environment, such as in the last known direction of the object, to attempt to reacquire the object. If the object is reacquired, tracking continues.

Accordingly, in one aspect, a process for tracking and following an object involves receiving sensory data into memory from a robot. Objects in an environment of the robot are tracked using the sensory data. The robot is directed to move so as to maintain a relative position and orientation of the robot with respect to one or more of the tracked objects. The movement of the robot is controlled so as to avoid obstacles using the sensory data.

In another aspect, a computing machine for tracking and following an object includes an object recognition module having an input receiving sensory data from an environment of a robot and an output indicating objects recognized in the environment. A track and follow module has an input indicating a selected object to be tracked and an output indicating a position and orientation for the robot to follow the selected object. A navigation module has an input receiving the position and orientation and an output to a motion control system of the robot directing the robot to move to the desired position and orientation along a path to avoid obstacles.

In one embodiment, a user is enabled to select one or more of the tracked objects which the robot is directed to follow. The user can be provided with a live video feed with tracked objects indicated in the live video feed.

In another embodiment, if tracking of an object loses an object then the process further includes attempting to reacquire tracking of the lost object. Attempting to reacquire tracking of the lost object can include adjusting the position and orientation of the robot.

In one embodiment, two robots can maintain a session in which each robot tracks and follows a person in its environment. In this way, two people in different locations, each with a robot, can “visit” each other, e.g., see and hear each other, as they each move around their respective environments, if both robots track and follow the respective participants, keeping them in camera frame. Each person can instruct the respective robot to follow himself or herself. By maintaining the relative position and orientation of the robot with respect to the person, a camera and microphone can remain directed at the person.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example mobile robot system.

FIG. 2 is a data flow diagram illustrating an example implementation of tracking and following.

FIG. 3 is a flow chart describing an operation of the system of FIG. 2.

FIG. 4 is a flow chart describing an example setup for a robotic telepresence application.

FIG. 5 is a block diagram of an example computing device in which such a system can be implemented.

### DETAILED DESCRIPTION

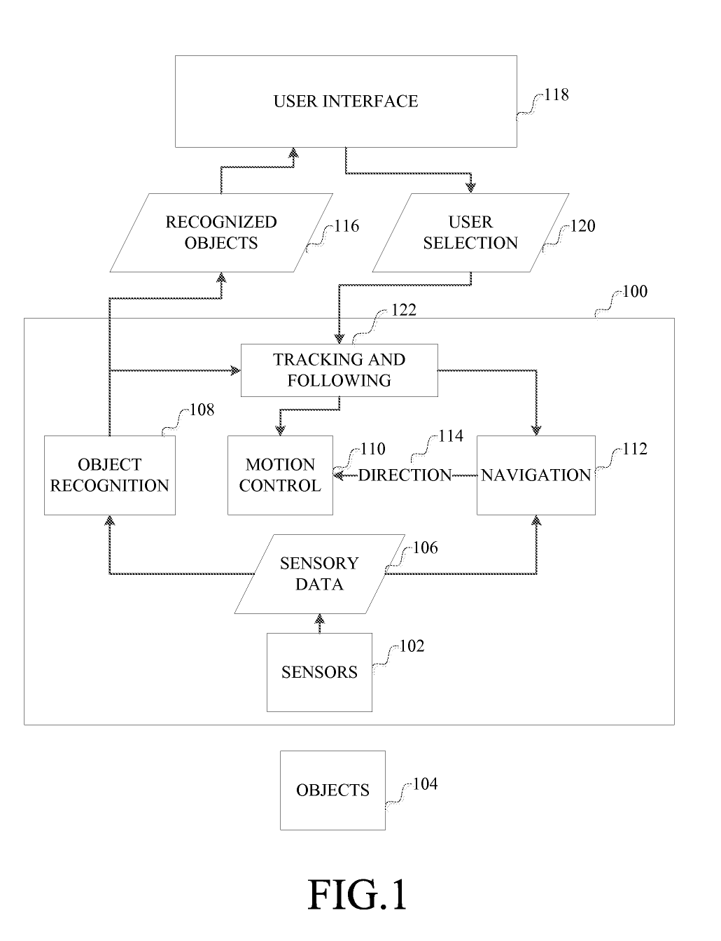

The following section provides an example operating environment in which the tracking and following by a robot can be implemented. Referring to FIG. 1, a mobile robot 100 has several components.

Sensors 102 detect information about the surrounding environment and objects 104 in that environment. The sensors 102 provide sensory data 106 as input to the rest of the robot's systems. Example sensors include, but are not limited to, one or more video cameras, one or more microphones, such as a microphone array, infrared detectors, and proximity detectors. The invention is not limited to a particular set of or arrangement of sensors 102, so long as the sensory data 106 provided by the sensors enables objects to be recognized and tracked or obstacles to be avoided.

An object recognition module 108 uses the sensory data 106 to identify objects, and their locations and orientations in space relative to the robot 100. A motion control module 110 controls the direction and speed of motion of the robot 100. An navigation module 112 determines the direction 114 for the motion control module, based on obstacle avoidance, and other path following processes. The object recognition, motion control and navigation systems can be implemented in any of a number of ways known to those of ordinary skill in the art and the invention is not limited thereby.

At regular time frames, the object recognition module provides the information about the recognized objects 116, including a position and orientation of each object and information describing the object, such as an identifier for the object. A variety of pattern recognition techniques can be applied to the sensory inputs of the robot to recognize objects. For example, the object recognition module 108 can use video information and process images to identify specific shapes or faces. Proximity detectors can provide information about the distance of the object to the robot 100. By processing images over time, and tracking objects, the object recognition module 108 can determine whether an object is moving. Sound source localization can be used to identify the location of an object making a sound, such as a person and his or her voice. The object recognition module 108 provides information about the recognized objects 116 to a user interface 118 and a tracking and following module 122 to be described in more detail below.

In many applications, the object to be recognized and tracked is a person. The recognition and tracking can recognize a part of an object, such as a face. Once an object is recognized, it can be tracked by monitoring a point or region of the object. For example, if the robot follows a person, it can first recognize the face and then follow a point or area on the body.

In an example implementation, a user interface 118 allows a user to view information about the recognized objects and provide a user selection 120, indicating which object to be tracked and followed by the robot 100. The user selection 120 is provided to a tracking and following module 122 in the robot 100, which determines how the robot 100 tracks and follows the object, using information from the object tracking module 108, and directing the navigation module 112. In another implementation, the user interface processes the sensory data to determine an operator's instructions. For example, a user may say “follow” or gesture to provide the user selection 120, instructing the robot 100 to follow the person or object recognized its field of view.

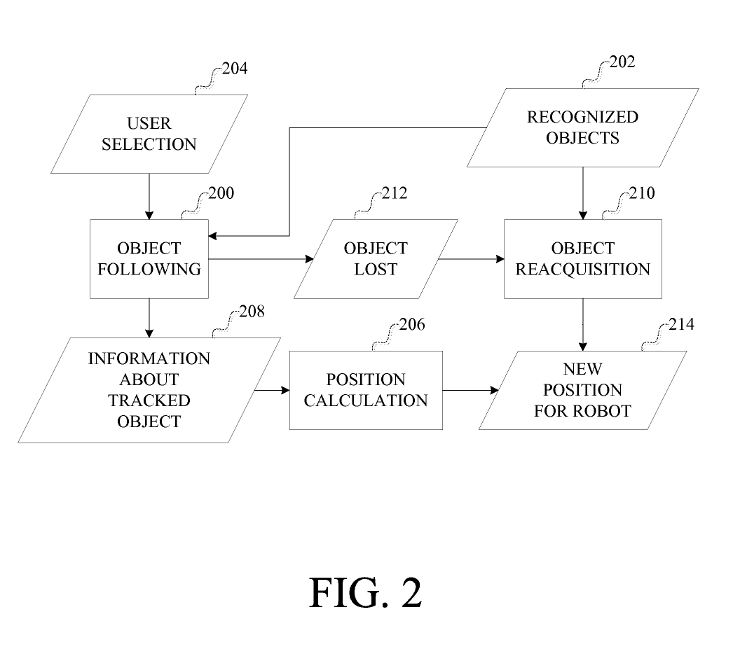

Given this context, an example implementation of the tracking and following module 122 will be described in more detail in connection with FIGS. 2-4.

In FIG. 2, a block diagram of an example implementation of this module includes an object following module 200 which receives information about the recognized objects 202. This information includes, for example, an identifier for each recognized object and its position. An indication of the current user selection 204 instructs the object following module about the object to be tracked.

Given the information about the recognized objects 202 and the user selection 204, the object following module 200 performs several operations in several modes. First, if there is no selected object, then the object following module 200 is in a waiting mode and waits for a user selection.

If an object has been selected for following, the object following module 200 begins a tracking mode. In the tracking mode, if the position of the object remains within a threshold distance from its original position or otherwise remains in the field of view of the robot, the robot does not move. For example, the module 200 can determine if an object in an image is within a bounding box within the field of view of the robot. Also, the module can determine if the depth of the object, or distance between the robot and the object, is within a predetermined range. If the position of the tracked object changes significantly, then the object following module informs a position calculation module 206 that the robot needs to be moved to follow the tracked object. The object following module 200 provides information 208 about the object to the position calculation module 206, such as its position, orientation and its direction and velocity of movement.

The position calculation module 206 receives the information 208 about the tracked object and provides as its output a new position 214 for the robot. This may be a new x,y position or a new orientation or both. For example, the robot may be instructed to rotate 45 degrees. The robot can change its position and orientation to match a desired relative position and orientation with respect to the object. The new position information 214 is provided to the navigation control system of the robot.

If the selected object is no longer found in the information about the recognized objects, the module 200 enters a reacquisition mode and informs an object reacquisition module 210, such as with an “object lost” message 212, and other information about the recognized object. For example, the direction and speed of motion of the object can be useful information.

Given the user selection 204, the object reacquisition module 210 determines how to relocate the object, which involves moving the robot. Module 210 determines a new position 214 for the robot. For example, given the direction and velocity of the object, it can compute a new position to which to move the robot from the current position of the robot, and a speed at which to move to that new position. Depending on the information available about the environment of the robot, other techniques may be used.

Until the object is reacquired, or reacquisition is terminated by either a time out or by the user, the object reacquisition module uses information about the object lost, and information received about recognized objects, to relocate the object. In particular, the object reacquisition module compares the information about recognized objects in a given time frame to the information it has about the lost object. If a match is found, then the matched object is now the object to be tracked by the object following module 200. The object reacquisition module provides information about the matched object back to the object following module, which resumes tracking.

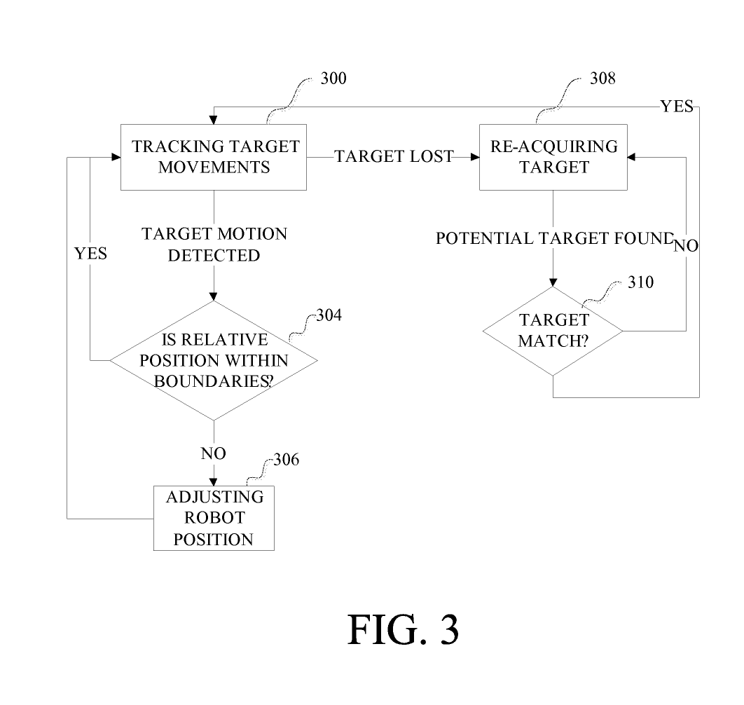

A flow chart describing the operation of the system of FIG. 2 will now be described in connection with FIG. 3.

The process begins after the robot is engaged to track and follow an object. When tracking and following an object, the robot detects 300 the object's motion, such as by changes in position or size. In particular, it tracks the object's three dimensional data, including position and velocity. If motion is detected, then the robot determines 302 whether the amount of motion is sufficient enough for the robot to move or have some other reaction. For example, the robot may determine if the relative distances and orientations are within certain boundaries. The specific boundaries will depend on the application or use of the robot. Note that if an orientation of a tracked object can be tracked, this orientation information can be used to move the robot to ensure that the robot is “facing” the object, or that its orientation matches a desired orientation with respect to the object.

If the relative position and orientation of the object and the robot are not within predetermined boundaries, then the robot position and orientation can be adjusted 304. Given a desired position and orientation, the path and speed of movement can be determined by a navigation system according to the application or use of the robot. For example, the navigation system may follow the shortest path, and maintain a close following distance to the object. The navigation system also may attempt to follow the same path followed by the object.

Other reactions to the robot also can be provided. For example, the positions of a camera, microphone or other sensor can be changed. If the robot has other movable parts, only certain parts can be moved. Other information indicating the state of the robot, or its expression, can be provided. Sounds or displays, for example, could be output to indicate that the robot is anticipating a loss of the tracked object.

After the robot reacts to the motion of the object, the robot continues to track 300 the object. If tracking fails, the process continues with step 308 of reacquiring the object. If a potential target is found, and a match with the original object is made, as determined at 310, then processing returns to tracking 300 the object. Otherwise, the system continues to attempt to reacquire 308 the object.

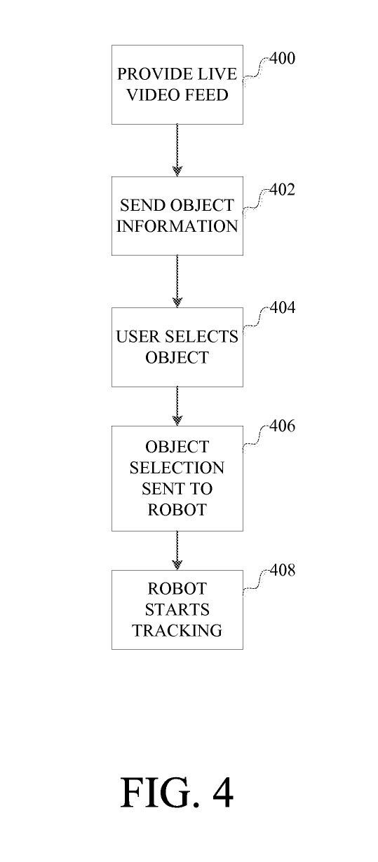

Referring now to FIG. 4, a process for starting tracking and following of the object will now be described. In FIG. 1, a user interface allows a user to be informed of the recognized objects and select an object for tracking. As an example implementation, a robotic telepresence session provides 400 a live video feed from the robot. This session is typically implemented as a client application running on a remote computer connected through a communication link with the robot. The object recognition module of the robot computes positions of objects and sends 402 this information to the client application. A user interface for the client application can display information that identifies 404 the objects in the live video feed, such as an overlay of an indication of the recognized objects. The user is then allowed to select 404 an object, and the selection is sent 406 to the robot. On receipt of the selection, the robot enters 408 the track and follow mode for the target. The user interface also can be provided with mechanism to allow the user to cancel this mode or select a new object or person to follow.

A number of applications can be implemented using this technique of tracking and following objects by a robot. For example, a robotic telepresence session can be simplified by directing the robot to follow a selected object. A robot can also be directed by an operator to follow the operator or another object, freeing the operator from the task of directing the robot to move.

In one embodiment, two robots can maintain a session in which each robot tracks and follows a person in its environment. In this way, two people in different locations, each with a robot, can “visit” each other, e.g., see and hear each other, as they each move around their respective environments, if both robots track and follow the respective participants, keeping them in camera frame. Each person can instruct the respective robot to follow himself or herself. By maintaining the relative position and orientation of the robot with respect to the person, a camera and microphone can remain directed at the person.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. A mobile robot typically has computing power similar to other well known computing devices such as personal computers, hand-held or laptop devices (for example, media players, notebook computers, cellular phones, personal data assistants, voice recorders), multiprocessor systems, microprocessor-based systems, set top boxes, game consoles, programmable consumer electronics, and the like. Because the control system for the robot also may be on a computer separate and/or remote from the robot, other computing machines can be used to implement the robotic system described herein.

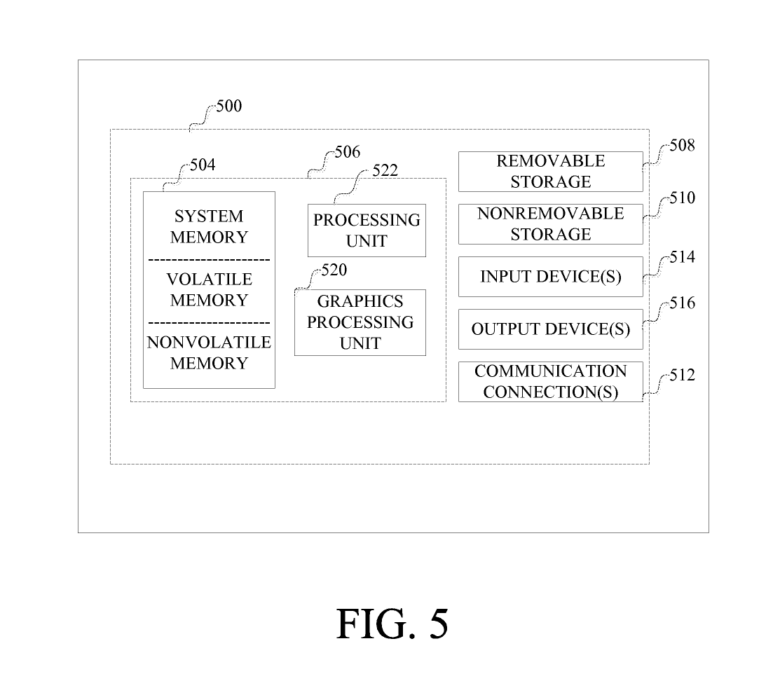

FIG. 5 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 5, an example computing environment includes a computing machine, such as computing machine 500. In its most basic configuration, computing machine 500 typically includes at least one processing unit 502 and memory 504. The computing device may include multiple processing units and/or additional co-processing units such as graphics processing unit 520. Depending on the exact configuration and type of computing device, memory 504 may be volatile (such as RAM), non-volatile (such as ROM, flash memory, etc.) or some combination of the two. This most basic configuration is illustrated in FIG. 5 by dashed line 506. Additionally, computing machine 500 may also have additional features/functionality. For example, computing machine 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer program instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 500. Any such computer storage media may be part of computing machine 500.

Computing machine 500 may also contain communications connection(s) 512 that allow the device to communicate with other devices. Communications connection(s) 512 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 500 may have various input device(s) 514 such as a display, a keyboard, mouse, pen, camera, touch input device, and so on. Output device(s) 516 such as speakers, a printer, and so on may also be included. All of these devices are well known in the art and need not be discussed at length here.

Such a system may be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving sensory data into memory from a robot;
tracking one or more objects in an environment of the robot using the sensory data;
directing the robot to move so as to maintain a relative position and orientation of the robot with respect to one or more of the tracked objects; and
controlling the movement of the robot so as to avoid obstacles using the sensory data.

2. The computer-implemented process of claim 1, further comprising:
enabling a user to select one or more of the tracked objects which the robot is directed to follow.

3. The computer-implemented process of claim 2, further comprising:
providing the user with a live video feed and indicating tracked objects in the live video feed.

4. The computer-implemented process of claim 3, wherein if tracking of an object loses an object then the process further comprises:
attempting to reacquire tracking of the lost object.

5. The computer-implemented process of claim 4, wherein attempting to reacquire tracking of the lost object comprises adjusting the position and orientation of the robot.

6. The computer-implemented process of claim 1, wherein if tracking of an object loses an object then the process further comprises:
attempting to reacquire tracking of the lost object.

7. The computer-implemented process of claim 6, wherein attempting to reacquire tracking of the lost object comprises adjusting the position and orientation of the robot.

8. The computer-implemented process of claim 1, wherein the tracked object is a person, and further comprising providing a second robot in a second environment and:
receiving sensory data into memory from a second robot;
tracking a person in the second environment of the second robot using the sensory data;
directing the second robot to move so as to maintain a relative position and orientation of the robot with respect to the tracked person in the second environment; and
controlling the movement of the robot so as to avoid obstacles using the sensory data.

9. An article of manufacture comprising:
a computer storage medium;
computer program instructions stored on the computer storage medium which, when processed by a processing device, instruct the processing device to perform a process comprising:
receiving sensory data into memory from a robot;
tracking objects in an environment of the robot using the sensory data;
directing the robot to move so as to maintain a relative position and orientation of the robot with respect to one or more of the tracked objects;
controlling the movement of the robot so as to avoid obstacles using the sensory data;

10. The article of manufacture of claim 9, wherein the process performed further comprises:
enabling a user to select one or more of the tracked objects which the robot is directed to follow.

11. The article of manufacture of claim 10, wherein the process performed further comprises:
providing the user with a live video feed and indicating tracked objects in the live video feed.

12. The article of manufacture of claim 11, wherein if tracking of an object loses an object then the process further comprises:
attempting to reacquire tracking of the lost object.

13. The article of manufacture of claim 12, wherein attempting to reacquire tracking of the lost object comprises adjusting the position and orientation of the robot.

14. The article of manufacture of claim 9, wherein if tracking of an object loses an object then the process further comprises attempting to reacquire tracking of the lost object by adjusting the position and orientation of the robot.

15. A computing machine comprising:
an object recognition module having an input receiving sensory data from an environment of a robot and an output indicating objects recognized in the environment;
a track and follow module having an input indicating a selected object to be tracked and an output indicating a position and orientation for the robot to follow the selected object; and
a navigation module having an input receiving the position and orientation and an output to a motion control system of the robot directing the robot to move to the desired position and orientation along a path to avoid obstacles.

16. The computing machine of claim 15, wherein the track and follow module includes an object tracking module having an input that receives information about the recognized objects and an output indicating whether the selected object is within predetermined boundaries;

17. The computing machine of claim 16, wherein the track and follow module includes a position calculation module having an input for receiving the output indicating whether the selected object is within predetermined boundaries and an output providing a position and orientation for the robot in which the object is within the boundaries.

18. The computing machine of claim 17, wherein the track and follow module includes an object reacquisition module having an input receiving information about the recognized objects, and an output providing the desired position and orientation to move the robot to attempt to reacquire the selected object.

19. The computing machine of claim 18, further comprising a user interface providing a user with information about the recognized objects and having a mechanism allowing a user to select one of the recognized objects.

20. The computing machine of claim 19, wherein the user interface includes a live video feed and indication of objects recognized in the live video feed.
